(19) United States
(12) Patent Application Publication
(10) Pub. No.: US 2024/0066826 A1
(43) Pub. Date: Feb. 29, 2024

(54) RESEALABLE ENCLOSURE HAVING FASTENER STRIPS, AND A METHOD AND SYSTEM FOR MAKING THE SAME

(71) Applicant: Illinois Tool Works Inc., Glenview, IL (US)

(72) Inventors: David J. Matthews, Gilman, IL (US); Eric P. Plourde, Frankfort, IL (US)

(73) Assignee: Illinois Tool Works Inc., Glenview, IL (US)

(21) Appl. No.: 18/364,385

(22) Filed: Aug. 2, 2023

Related U.S. Application Data
(60) Provisional application No. 63/400,947, filed on Aug. 25, 2022.

(51) Int. Cl. B31B 70/81; B65D 33/25

(52) U.S. Cl. CPC B31B 70/8131; B65D 33/25; B31B 2155/001

(57) ABSTRACT

A method is provided that includes moving a first web of flexible material in a web direction. The method then includes attaching fastener strips to the first web. The fastener strips are spaced-apart a predetermined distance along a transverse direction to the web direction. An enclosure is formed from the first web including a front wall, a back wall, a first lateral side wall, and a second lateral side wall. The front wall opposes the back wall, and the first lateral side wall opposes the second lateral side wall. The enclosure includes an upper end openable by separating the fastener strips. Corners are formed in the enclosure between the front wall, the back wall, the first lateral side wall, and the second lateral side wall. The corners are formed from the predetermined distance between the fastener strips and the fastener strips are spaced apart from each other by the corners.

### CROSS-REFERENCE TO RELATED APPLICATIONS

This application claims priority to U.S. Provisional Patent Application No. 63/400,947, which was filed on 25 Aug. 2022, and the entire disclosure of which is incorporated herein by reference.

### BACKGROUND

### Technical Field

The subject matter described herein relates to enclosures, specifically resealable enclosures with fastener strips for resealing the enclosure.

### Discussion of Art

Flexible enclosures can hold a variety of material. One example of a flexible enclosure is a gusseted package that creates a free-standing package with increased volumetric capacity. These enclosures may include a fastener strip to reseal the enclosure. The enclosure may be formed from a web of flexible material. Typically, these enclosures may have their gussets sealed together so that only the front panel may open for access. In examples where the gussets are not sealed together, the fastener strip may need to be a long, thin strand of a self-mating closure pushed across a web and sealed to the web.

This approach to manufacturing the enclosures and fastener strips may be difficult and may result in improperly formed enclosures. Laying a continuous fastener strip across the web may also make it difficult to create sealed corners of the gusseted sides as the thickness of the fastener strip may create a gap through which air and/or product can pass.

It may be desirable to have enclosures that differs from those that are currently available.

### BRIEF DESCRIPTION

In one example, a method is provided including moving a first web of flexible material in a web direction. The method may include attaching fastener strips to the first web of flexible material. The fastener strips may be spaced-apart a predetermined distance along a transverse direction that is transverse to the web direction. The method may include forming an enclosure from the first web including a front wall, a back wall, a first lateral side wall, and a second lateral side wall. The front wall opposes the back wall and the first lateral side wall opposes the second lateral side wall. The enclosure may include an upper end openable by separating the fastener strips. The method may include forming corners in the enclosure between the front wall, the back wall, the first lateral side wall, and the second lateral side wall. The corners may be formed from the predetermined distance between the fastener strips, wherein the fastener strips are spaced apart from each other by the corners.

In one example, an enclosure is provided that may include a front wall, a back wall, a first lateral side wall, and a second lateral side wall. The front wall may oppose the back wall and the first lateral side wall may oppose the second lateral side wall. The walls of the enclosure may be formed from a flexible material. Fastener strips may be coupled to an interior portion of the front wall, the back wall, the first lateral side wall, and the second lateral side wall. The fastener strips may be spaced-apart a predetermined distance. The enclosure may include an upper end openable by separating the fastener strips. The enclosure may include corners between the front wall, the back wall, the first lateral side wall, and the second lateral side wall. The corners may be formed from the predetermined distance between the fastener strips, wherein the fastener strips are spaced apart from each other by the corners.

In another example, a system is provided including a first actuator configured to unwind a first web of flexible material in a web direction. The system may include a zipper applicator that may apply fastener strips to the first web. The fastener strips may be spaced-apart a predetermined distance along a transverse direction that is transverse to the web direction. An assembly may be included to fold the first web at the predetermined distances between the fasteners into an enclosure. The enclosure may include corners at the predetermined distances. The corners may connect a front wall, a back wall, a first lateral side wall and a second lateral side wall extending between the front wall and the back wall. The enclosure may include an upper end, where the upper end may be openable by separating the fastener strips.

### BRIEF DESCRIPTION OF THE DRAWINGS

The inventive subject matter may be understood from reading the following description of non-limiting embodiments, with reference to the attached drawings, wherein below:

FIG. 1 illustrates a perspective view of one example of a re-closeable or resealable enclosure;

FIG. 2 illustrates an interior view of one example of a flexible material with fastener strips attached, shown in an unfolded position;

FIG. 3 illustrates a top view of one example of a re-closeable or resealable enclosure;

FIG. 4 illustrates a perspective view of one example of a system for forming the re-closeable or resealable enclosure shown in FIG. 1;

FIG. 5 illustrates a flow chart showing a method of manufacturing a re-closeable or resealable enclosure, according to one example; and

FIG. 6 illustrates a top view of one example of a re-closeable or resealable enclosure.

### DETAILED DESCRIPTION

One or more embodiments of the inventive subject matter set forth herein include a resealable flexible enclosure or gusseted bag, methods of making the same, and systems for making the enclosures or bags. The flexible enclosure may be formed from a single web of flexible material. In one example, the flexible enclosure may include at least two discrete sections or segments that form walls of the flexible enclosure. An access opening can be formed, through which contents (e.g., product) may pass into or out of the flexible enclosure. Optionally, the access opening can be formed when a top portion of the flexible enclosure is removed. The access opening may be sealed and re-sealed. In particular embodiments, the flexible enclosure may be manufactured using a machine such as a Totani pouch-making machine (e.g., BH Series or FD Series machine).

The sections that form the flexible enclosure (e.g., a front wall, a back wall, and two side walls or gusseted walls) may be formed from a single piece of flexible material. In one example, the sections (or segments) that form the flexible enclosure may be discrete because the sections are separate from each other prior to being attached to each other. The sections may be provided by at least two different continuous webs of flexible material. For example, a first section (or front wall) and a second section (or back wall) may be essentially rectangular sections having edges. An edge of the first section may be either attached to an edge of the second section (e.g., along a top or bottom of the flexible enclosure) or attached to an edge of the side wall. Likewise, an edge of the second section may be either attached to an edge of the first section (e.g., along a top or bottom of the flexible enclosure) or attached to an edge of the side wall.

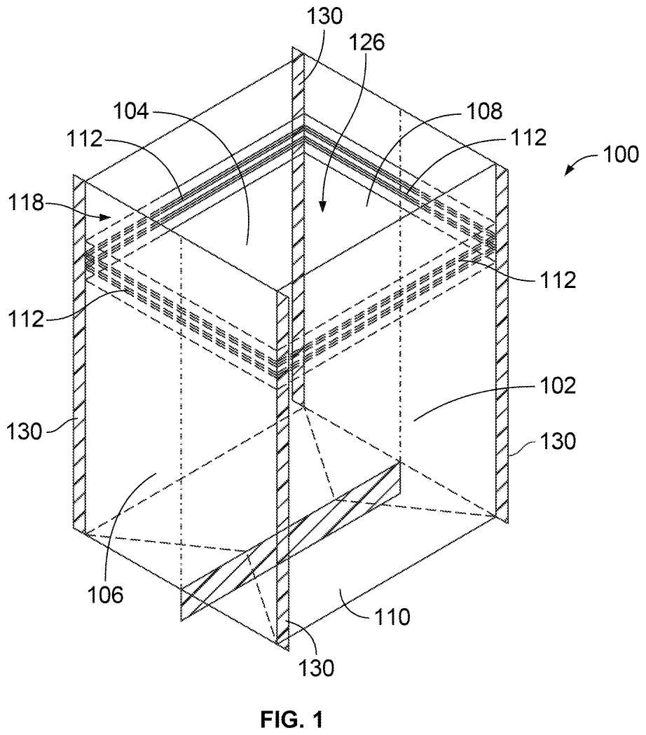

FIG. 1 shows a perspective view of one example of a flexible enclosure 100. The enclosure 100 may be formed from a flexible material 140. The flexible enclosure includes a front wall (or first wall) 102, a back wall (or second wall) 104, a first lateral side wall 106, and a second lateral side wall 108. In one example, the front wall 102 may be on an opposite side of the enclosure 100 relative to the back wall 104. The first lateral side wall 106 may be on an opposite side of the enclosure 100 relative to the second lateral side wall 108. Each lateral side wall 106, 108 may extend from the front wall 102 to the back wall 104, and each of the front wall 102 and the back wall 104 may extend from one lateral side wall to the other lateral side wall.

The first and second lateral side walls 106, 108 may be gusseted side walls. The gusseted side walls may be V-shaped with apices. Apices may be formed as folds or creases in a single web sheet. Gussets may increase the volume which may be formed between the front wall 102 and the back wall 104 when the enclosure is filled. In one example, the flexible enclosure may include a bottom wall 110 that extends from the front wall 102 to the back wall 104 and from one lateral side wall to the other lateral side wall. The front wall 102, the back wall 104, and the first and second lateral side walls 106, 108 may all be coupled to the bottom wall 110. The flexible enclosure 100 may be able to sit on the bottom wall 110. The walls may be formed from a single piece of flexible material 140. The flexible enclosure 100 may have an upper end 118 with an opening 126 that is openable to access an interior of the enclosure. Gussets may increase the size of the opening 126 at the upper end 118 of the enclosure.

The enclosure 100 may include fastener strips 112 on the interior surface of the enclosure 100. As illustrated in FIG. 1, the enclosure 100 may have multiple fastener strips 112 that, as a group, extend around nearly the entire perimeter of the interior surface of the enclosure 100. In one example, the fastener strips 112 may be coupled to the front wall 102, the back wall 104, and the first and second lateral side walls 106, 108 but with spatial gaps between the ends of the fastener strips at corners or intersections between the walls. The fastener strips 112 may be positioned near the upper end 118 of the enclosure. The fastener strips 112 may be pulled apart (e.g., by a consumer pulling on opposite sides of the enclosure 100) to open the upper end 118 enclosure 100. After opening, the enclosure 100 may be closed by pressing the opposite front 102 and back walls 104 toward each other. For example, the fastener strips 112 of the front and back walls, respectively, may engage each other. The fastener strip 112 along the first lateral side wall 106 may engage itself and/or the fastener strip 112 along the second lateral side wall 108. Optionally, portions of the fastener strips of the front and back walls may engage the fastener strips along the first and second lateral side walls.

In one example, the fastener strips 112 may include a single self-mating fastener strip. A self-mating fastener strip includes a self-mating zipper strip, an intermeshing closure member, an adhesive reseal, or the like. An intermeshing closure member may include a strip of a structured surface having ridges and troughs that can mate with itself. An intermeshing closure member may include two opposing hook-filled strips having the same or similar structure. When brought together, the hooks of one strip may couple to the hooks of the opposing strip, thereby sealing the enclosure. The hooks may be positioned to engage on multiple levels. Widths of the intermeshing closure members may be sized and positioned so that precise alignment is not required.

In one example, the fastener strips 112 may include a male interlocking feature and a female interlocking feature. The female interlocking features may be receptacles shaped to receive and secure outer ends of the male interlocking features (to keep the enclosure 100 closed). Pulling apart opposite walls (e.g., the front wall and back wall, the first lateral side wall and the second lateral side wall) may remove the male interlocking feature from the female interlocking feature to open the enclosure 100. In one example, a slider may be used that moves along the length of the fastener strips 112 to open or close the fastener strips 112 and enclosure 100. Alternatively, the fastener strips 112 may be opened or closed without the slider.

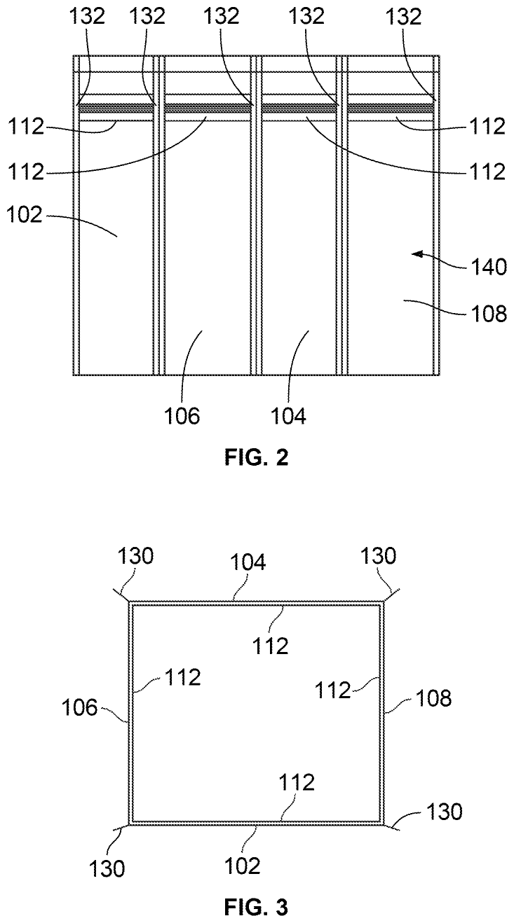

FIG. 2 illustrates an interior view the flexible material 140 with the fastener strips 112 attached, where the flexible material 140 is shown in an unfolded position. The flexible material 140 may be folded to create the walls and form the finished enclosure 100, as is shown in FIG. 1. The fastener strips 112 may be shown as four distinct parts. The fastener strips 112 may be spaced-apart a predetermined distance to create one or more gaps 132. The gaps 132 may be between 1 millimeter and 15 millimeters. In one example, the gaps may be greater than 15 millimeters. The gaps 132 may be sized and positioned such that the enclosure may be folded and the gaps 132 may form one or more corners 130 of the enclosure 100, shown in FIGS. 1 and 3 and discussed below. The corners 130 may be formed between the front wall 102, the back wall 104, the first lateral side wall 106, and the second lateral side wall 108. For example, a first corner may be formed between the front wall and the first lateral side wall, a second corner may be formed between the first lateral side wall and the back wall, a third corner may be formed between the back wall and the second lateral side wall, and a fourth corner may be formed between the second lateral side wall and the back wall. In the example illustrated in FIG. 2, the fastener strips 112 extend along a transverse direction that is transverse to the web direction.

FIG. 3 illustrates a top view of the enclosure 100 where the flexible material 140 has been folded to form the walls. The enclosure 100 is shown with the fastener strips 112 separated such that the upper end 118 and opening 126 are open. The flexible material 140 may be folded at each gap 132, such that each gap 132 may become a corner 130 of the enclosure 100. By providing the gaps 132 between the fastener strips 112 and forming the corners 130 at each gap 132, it is possible to have no portion of any fastener strip 112 extend into the corner 130. This helps alleviate deformation that may be caused by a portion of the fastener strip 112 entering the corner 130. Additionally, this arrangement may increase the volume and strength of the enclosure while reducing excess materials used.

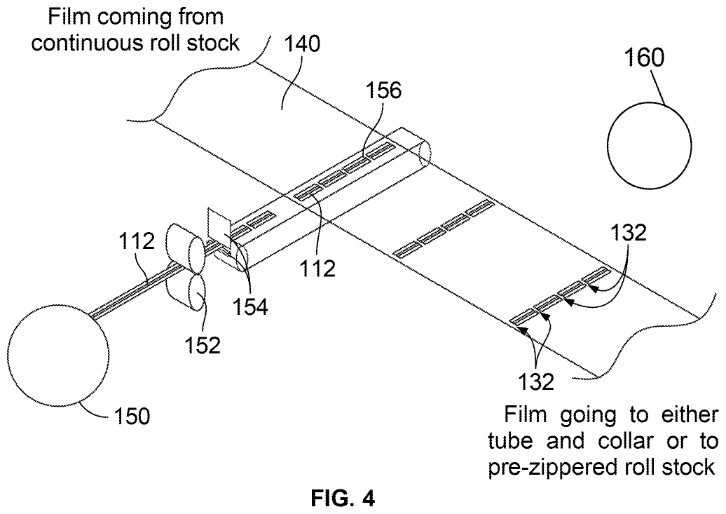

A process for manufacturing the enclosure is shown schematically in FIG. 4. As shown in FIG. 4, the manufacturing line generally progresses from top to bottom such that the flexible material 140 with the fastener strips 112 attached is at the lower right portion of the figure. A length of flexible material 140 may be released at the top of the figure. The flexible material 140 may be released from a continuous roll of stock material. The fastener strip 112 may be unrolled from a spool 150 adjacent to the web of flexible material 140. The spool 150 may be transverse (e.g., perpendicular) to the flexible material 140. The fastener strip may be fed through a drive 152, such as a servo motor drive, that may measure out predetermined lengths of the fastener strip. A cutting member 154, such as a blade or knife, may then cut the fastener strips 112 at the predetermined lengths. The cutting member 154 may cut the fastener strips 112 at the predetermined lengths such that a gap 132 may be left between adjacent portions of the cut fastener strips 112. The predetermined lengths of the fastener strip 112 may then be feed onto a feeding belt 156 to place a predetermined number of fastener strips 112 on to the flexible material 140. In one embodiment, the predetermined number of fastener strips 112 may be four, however in other embodiments, the predetermined number of fastener strips 112 may be two, three, or more than four. A seal bar may then be positioned to contact and seal the fastener strips 112 to the flexible material 140. The seal bar may heat seal the fastener strips 112 to the flexible material 140. In other embodiments, the fastener strips may be coupled to the flexible material 140 by other means, such as by using adhesives. Once the fastener strip 112 has been attached to the flexible material 140, an unfolded enclosure may be formed, as is shown in FIG. 2. The unfolded enclosure may then be entered into an assembly 160, for example a bag or pouch making machine, to be made into the fully formed enclosure, as shown in FIG. 1.

By forming gaps 132 between the fastener strips 112 and then attaching the fastener strips 112 to the flexible material 140, the enclosure 100 may be formed with sealed corners 130 after the fastener strips 112 are attached. That is to say, previously it may have only been possible to form the sealed corners of an enclosure before the fastener strips were applied, and the fastener strips may then need to be subsequently applied. This may present a more difficult assembly and may create a less continuous fastener strip assembly.

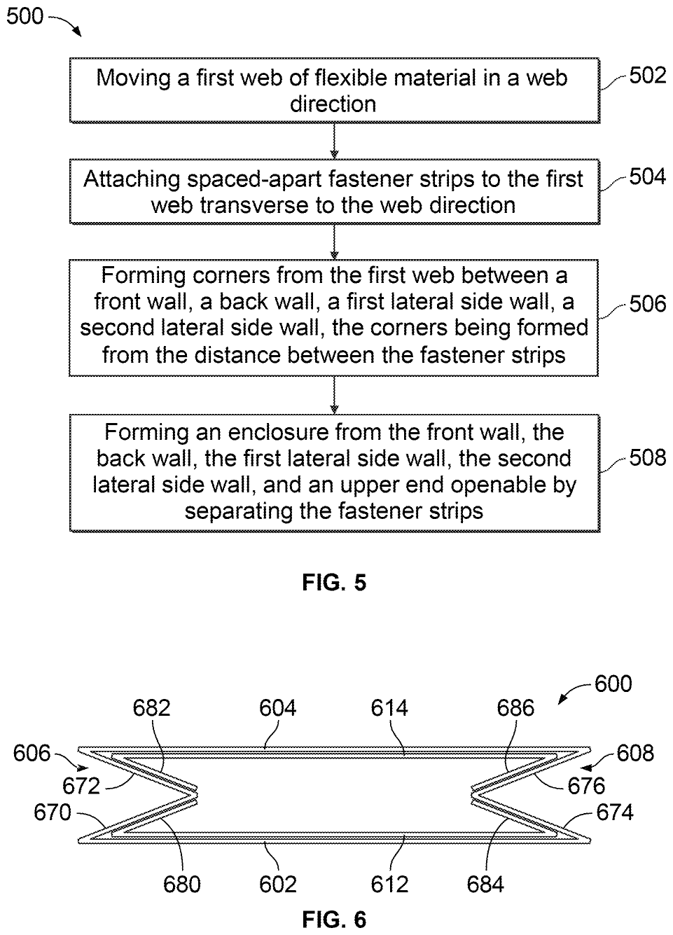

FIG. 5 illustrates a flow chart showing a method 500 of manufacturing re-closeable or resealable enclosure. The method includes at step 502 moving a first web of flexible material in a web direction. The flexible material may be a film, a paper, a re-pulpable material, or any other suitable material. The flexible material may be fed from a continuous roll of stock material or may be fed by a user.

At step 504, the method may include attaching fastener strips to the first web of flexible material. The fastener strips may include a single self-mating fastener strip, a male interlocking feature and a female interlocking feature, or another fastening configuration. The fastener strips may be spaced-apart a predetermined distance along a transverse direction that is transverse to the web direction.

At step 506, corners may be formed in the first web. The corners may be formed between a front wall, a back wall, a first lateral side wall, and a second lateral side wall. The corners may be formed from the predetermined distance between the fastener strips. The fastener strips may be spaced apart from each other by the corners. At step 508, the method may include forming an enclosure from the first web including the front wall, the back wall, the first lateral side wall, and the second lateral side wall. The front wall may be positioned opposite the back wall and the first lateral side wall may be positioned opposite the second lateral side wall. The enclosure may include an upper end that may be openable by separating the fastener strips. The enclosure may be formed from an assembly, for example a bag or pouch making machine.

FIG. 6 illustrates a top view of a re-closeable or resealable enclosure 600. The enclosure 600 is similar to the enclosure 100 discussed above, but may have a different fastener strip arrangement. The enclosure 600 may include a front wall 602, a back wall 604, a first lateral side wall 606, and a second lateral side wall 608. The first lateral side wall 606 may include a front facing portion 670 and a back facing portion 672. The second lateral side wall 608 may have a front facing portion 674 and a back facing portion 676. Each of the walls may include a fastener strip. In one embodiment, the front wall 602 may have a fastener strip that is a male interlocking element 612. The back wall 602 may include a fastener strip that is a female interlocking element 614 that may be positioned to couple with a portion of the male interlocking element 612 of the front wall 602. The front facing portions 670 and 674 of the lateral side walls may include female interlocking elements 680 and 684 that may be positioned to couple with a portion of the male interlocking element 612 of the front wall 602. The rear facing portions 672 and 676 of the lateral side walls may include male interlocking elements 682 and 686 that may be positioned to couple a portion of the female interlocking element 614 of the back wall 604.

In one example, a method is provided that may include moving a first web of flexible material in a web direction. The method may include attaching fastener strips to the first web of flexible material. The fastener strips may be spaced-apart a predetermined distance along a transverse direction that may be transverse to the web direction. The method may include forming an enclosure from the first web of flexible material. The enclosure may include a front wall, a back wall, a first lateral side wall, and a second lateral side wall. The front wall may be opposite or opposing the back wall. The first lateral side may be opposite or opposing the second lateral side wall. The enclosure may include an upper end openable by separating the fastener strips. The method may include forming corners in the enclosure between the front wall, the back wall, the first lateral side wall, and the second lateral side wall. The corners may be formed from the predetermined distance between the fastener strips. The fastener strips may be spaced apart from each other by the corners.

Four corners may be formed in the enclosure between the front wall and the first lateral side wall, the first lateral side wall and the back wall, the back wall and the second lateral side wall, and the second lateral side wall and the front wall.

The method may include sealing the fastener strips to the first web of flexible material using a seal bar. Gusseted side walls may be formed at the first lateral side wall and the second lateral side wall. The fastener strips may extend along an interior surface of the enclosure. A bottom wall may be formed, where the bottom wall may be connected to the front wall, the back wall, and the first and second lateral side walls.

The fastener strips may be formed from a self-mating zipper assembly. In another example, the fastener strips may be formed from one or more male locking portions and one or more female locking portions. At least one of the male locking portions may be attached to the front wall and at least one of the female locking portions may be attached to the back wall. At least one of the male locking portion mays be attached to a back portion of the first lateral side and a back portion of the second lateral side. At least one of the female locking portions may be attached to a front portion of the first lateral side and a front portion of the second lateral side. The back portion of the first and second lateral sides may be positioned to engage the back wall in a closed position. The front portion of the first and second lateral sides may be positioned to engage the front wall in a closed position.

In another example, an enclosure is provided. The enclosure may include a front wall, a back wall, a first lateral side wall, and a second lateral side wall. The front wall may oppose or be opposing to the back wall. The first lateral side wall may oppose or be opposing to the second lateral side wall. The walls of the enclosure may be formed from a flexible material. The enclosure may include fastener strips coupled to an interior portion of the front wall, the back wall, the first lateral side wall, and the second lateral side wall. The fastener strips may be spaced-apart a predetermined distance. The enclosure may include an upper end that may be openable by separating the fastener strips. The enclosure may include corners between the front wall, the back wall, the first lateral side wall, and the second lateral side wall. The corners may be formed from the predetermined distance between the fastener strips. The fastener strips may be spaced apart from each other by the corners.

The fastener strips may be heat sealed to the interior portion. The fastener strips are a self-mating zipper assembly. In another example, the fastener strips include a male locking portion and a female locking portion. The male locking portion may be attached to the front wall and the female locking portion may be attached to the back wall.

The first and second lateral side walls may be gusseted side walls. The enclosure may include a bottom wall connected to the front wall, the back wall, and the first and second lateral side walls.

In another example, a system is provided that may include a first actuator, a zipper applicator, and an assembly. The first actuator may unwind a first web of flexible material in a web direction. The zipper application may apply fastener strips to the first web of flexible material. The fastener strips may be spaced-apart a predetermined distance along a transverse direction that is transverse to the web direction. The assembly may fold the first web of flexible material at the predetermined distances between the fasteners into an enclosure. The enclosure may include corners at the predetermined distances. The corners may connect a front wall, a back wall, a first lateral side wall, and a second lateral side wall of the enclosure. The enclosure may include an upper end. The upper end may be openable by separating the fastener strips.

The system may include a heat-sealing assembly that may couple the fastener strips to the flexible material. A seal bar may seal the fastener strips to the first web of flexible material. The first and second lateral side walls may be gusseted side walls.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A method comprising:
moving a first web of flexible material in a web direction;
attaching fastener strips to the first web of flexible material, the fastener strips spaced-apart a predetermined distance along a transverse direction that is transverse to the web direction;
forming an enclosure from the first web of flexible material including a front wall, a back wall, a first lateral side wall, and a second lateral side wall, the front wall opposing the back wall, the first lateral side wall opposing the second lateral side wall, the enclosure including an upper end openable by separating the fastener strips; and
forming corners in the enclosure between the front wall, the back wall, the first lateral side wall, and the second lateral side wall, the corners formed from the predetermined distance between the fastener strips, wherein the fastener strips are spaced apart from each other by the corners.

2. The method of claim 1, further comprising sealing the fastener strips to the first web of flexible material using a seal bar.

3. The method of claim 1, further comprising forming gusseted side walls at the first lateral side wall and the second lateral side wall.

4. The method of claim 1, further comprising extending the fastener strips along an interior surface of the enclosure.

5. The method of claim 1, further comprising forming a bottom wall connected to the front wall, the back wall, and the first and second lateral side walls.

6. The method of claim 1, further comprising forming the fastener strips from a self-mating zipper assembly.

7. The method of claim 1, further comprising forming the fastener strips from one or more male locking portions and one or more female locking portions.

8. The method of claim 7, further comprising attaching at least one of the one or more male locking portions to the front wall and attaching at least one of the one or more female locking portions to the back wall.

9. The method 8, further comprising attaching at least one of the one or more male locking portions to a back portion of the first lateral side and a back portion of the second lateral side and attaching at least one of the one or more female locking portions to a front portion of the first lateral side and a front portion of the second lateral side, wherein the back portion of the first and second lateral sides are positioned to engage the back wall in a closed position and the front portion of the first and second lateral sides are positioned to engage the front wall in a closed position.

10. An enclosure comprising:
a front wall, a back wall, a first lateral side wall, and a second lateral side wall, the front wall opposing the back wall, the first lateral side wall opposing the second lateral side wall, wherein the front wall, the back wall, the first lateral side wall, and the second lateral side wall of the enclosure are formed from a flexible material;
fastener strips coupled to an interior portion of the front wall, the back wall, the first lateral side wall, and the second lateral side wall, the fastener strips spaced-apart a predetermined distance;
an upper end openable by separating the fastener strips; and
corners positioned between the front wall, the back wall, the first lateral side wall, and the second lateral side wall, the corners formed from the predetermined distance between the fastener strips, wherein the fastener strips are spaced apart from each other by the corners.

11. The enclosure of claim 10, wherein the fastener strips are heat sealed to the interior portion.

12. The enclosure of claim 10, wherein the fastener strips include a self-mating zipper assembly.

13. The enclosure of claim 10, wherein the fastener strips include one or more male locking portions and one or more female locking portions.

14. The enclosure of claim 13, wherein the one or more male locking portions are configured to be attached to the front wall and the one or more female locking portions are configured to be attached to the back wall.

15. The enclosure of claim 10, wherein the first and second lateral side walls are gusseted side walls.

16. The enclosure of claim 10, further comprising a bottom wall connected to the front wall, the back wall, and the first and second lateral side walls.

17. A system comprising:
a first actuator configured to unwind a first web of flexible material in a web direction; and
a zipper applicator configured to apply fastener strips to the first web of flexible material, the fastener strips spaced-apart a predetermined distance along a transverse direction that is transverse to the web direction;
an assembly configured to fold the first web at the predetermined distances between the fasteners into an enclosure, the enclosure including corners at the predetermined distances, the corners connecting a front wall, a back wall, a first lateral side wall, and a second lateral side wall of the enclosure, wherein the enclosure includes an upper end, the upper end configured to be openable by separating the fastener strips.

18. The system of claim 17, further comprising a heat-sealing assembly configured to couple the fastener strips to the flexible material.

19. The system of claim 17, wherein a seal bar is configured to seal the fastener strips to the first web of flexible material.

20. The system of claim 17, wherein the first and second lateral side walls are gusseted side walls.
